(19) United States
(12) Patent Application Publication
(10) Pub. No.: US 2019/0287148 A1
(43) Pub. Date: Sep. 19, 2019

(54) PRODUCT INFORMATION MANAGEMENT SYSTEM USING BLOCK CHAIN REPOSITORY AND METHODOLOGY

(71) Applicant: TAI-SHENG HAN, New Taipei (TW)

(72) Inventor: TAI-SHENG HAN, New Taipei (TW)

(21) Appl. No.: 15/978,053

(22) Filed: May 11, 2018

(30) Foreign Application Priority Data
Mar. 16, 2018 (TW) 107108998

(51) Int. Cl. G06Q 30/06; H04L 29/06; H04L 9/06

(52) U.S. Cl. CPC G06Q 30/0601; H04L 2209/38; H04L 9/0637; H04L 63/102

(57) ABSTRACT

The present invention provides a decentralizing information establishment system for product assessment, which consists of at least one product and product manufacture end, at least one data node, at least one product use end. The product manufacture end transmits product information of the hardware product to a public network platform via one application, the data node retrieves and transforms the product information as a product information database, then stored on the public network platform. Moreover, the product use end also contributes updated information to the public network platform. The data node validates this information and turn into product information database and store on the public network platform. Accordingly, all of the factory/updated product information is explicitly stored on the public network platform after data node validation and proofs its sanity. Furthermore, compared to conventional trading, the actual product value can been judged fairly for product trading.

### BACKGROUND OF THE INVENTION

### (a) Field of the Invention

The present invention relates to a product information management system using block chain repository and methodology that enables maintaining and control explicit records of hardware products' factory information and end user historical usage data for further product value assessment, support and/or after-market customization and provide impartiality.

### (b) Description of the Prior Art

In general, after leaving the factory, each hardware product come with embedded manufacturing information, including and not limited to supplier name, product name, product model, date of production, warranty period, test data, and manufacturing place of origin. Most of this product information appears on the product specification sheet, and when any customer want to purchase a hardware product, the consumer is only able to review above information from sales clerk, or external packing, or introduction on the Internet. However, because it is not possible to truly and decisively obtain complete knowledge about the hardware product, thus, there is no corresponding guarantee for the consumer; moreover, there is the possibility of purchasing a hardware product that has been repaired, or even purchase an illegal counterfeit product with similar product information. And, after purchasing the hardware product, the consumer is unable to acquire further explicit knowledge about the product history of the hardware product. Moreover, after using the hardware product, the consumer discovers the hardware product has possibly undergone high wear and tear use or undergone maintenance by the original factory. However, the use history or maintenance history of the hardware product has not publicly disclosed this information. Furthermore, when the consumer wants to sell the hardware product, the subsequent consumer purchaser is unable to acquire first time knowledge of the use history or maintenance history of the hardware product, resulting in numerous consumer disputes occurring.

There are numerous methods to publish product history on the present market, the first and foremost of which use the integration and public disclosure of data from the manufacturers. However, such data registered or published by the manufacturers has a great many problems because all the data is from an integration of one-sided product information, and the integrated data is unable to achieve optimum impartiality. In addition, with the development of network technology, a single host computer is already unable to load and process a large quantity of files and a data bank. Although in recent times, hardware specifications of the host computer have continued to improve, or a plurality of connected host computers are used to strengthen computation processing capacity. However, when a failure occurs in the central data bank, the entire processing system is unable to operate. And although additional proposals have been developed using directory management methods, which first carry out index inquiring, and then the data bank of different host computers are entered to access files thereon. However, storing a directory management system on a core host computer still faces the risk of being unable to carry out inquiries when the core host computer fails. Hence, it is the strong desire of the author of the present invention and manufacturers engaged in related art, and purpose of the present invention to research, improve, and resolve the aforementioned problems and shortcomings of the prior art.

### SUMMARY OF THE INVENTION

Accordingly, in order to resolve the aforementioned problems, the primary object of the present invention lies in providing a product information management system using block chain repository and methodology that enables inquiring and updating explicit records of hardware products factory information and product history of use information to further facilitate assessment and provide impartiality.

In order to achieve the aforementioned object, the present invention provides a product information management system using block chain repository and methodology, wherein the product information management system comprises at least one manufacturer, at least one data node, and at least one end-user. The manufacturer presents at least one hardware product, and the presented hardware product of the manufacturer provides product information related thereto. The product information comprises at least first time information, and the manufacturer transmits the product information to a public network platform through an application. Then, the data node retrieves the product information through the application on the public network platform, and the data node transforms the retrieved product information to become a product information bank, whereupon the product information bank is stored on the public network platform through the application. In addition, the end-user can also access the aforementioned product information on the public network platform through the application. And after using the hardware product, the end-user produces product use information through the application. The product use information comprises at least one second time information, and the end-user transmits the product use information to the aforementioned public network platform. When the product use information is written to the public network platform, the data node verifies the product information and the product use information and forms the aforementioned product information bank, as well as storing the product information bank on the public network platform. Accordingly, the aforementioned hardware product factory information and product history of use information are explicitly recorded on the public network platform. Furthermore, the data node verifies the factory information and use information to enable facilitating assessment of the product information bank on the public network platform. Moreover, the characteristics of decentralized distribution computation and authentication and disallowing unilateral change of data enable providing traders with impartial grading standards when trading products.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of a product information management system of the present invention.

FIG. 2 is a block schematic view of the product information management system square of the present invention.

### DETAILED DESCRIPTION OF THE PREFERRED EMBODIMENTS

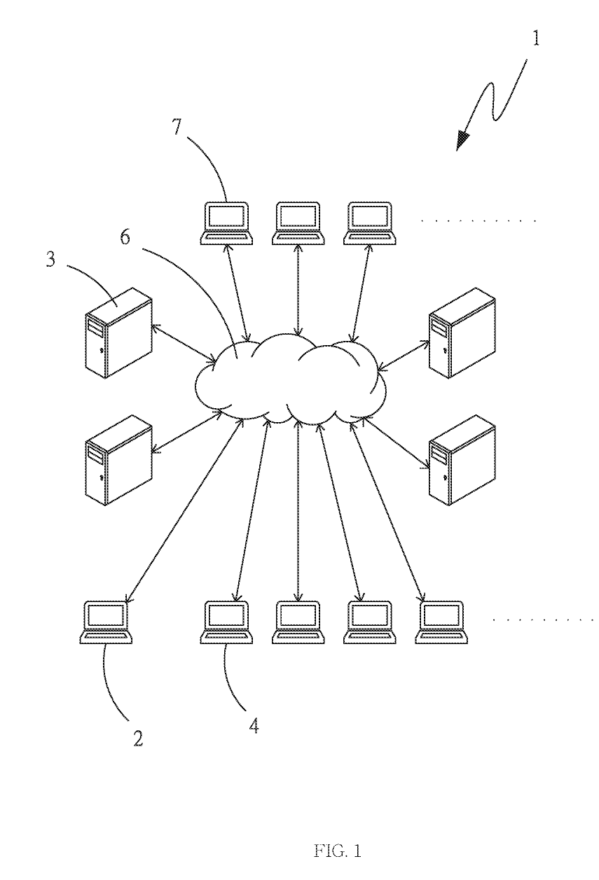

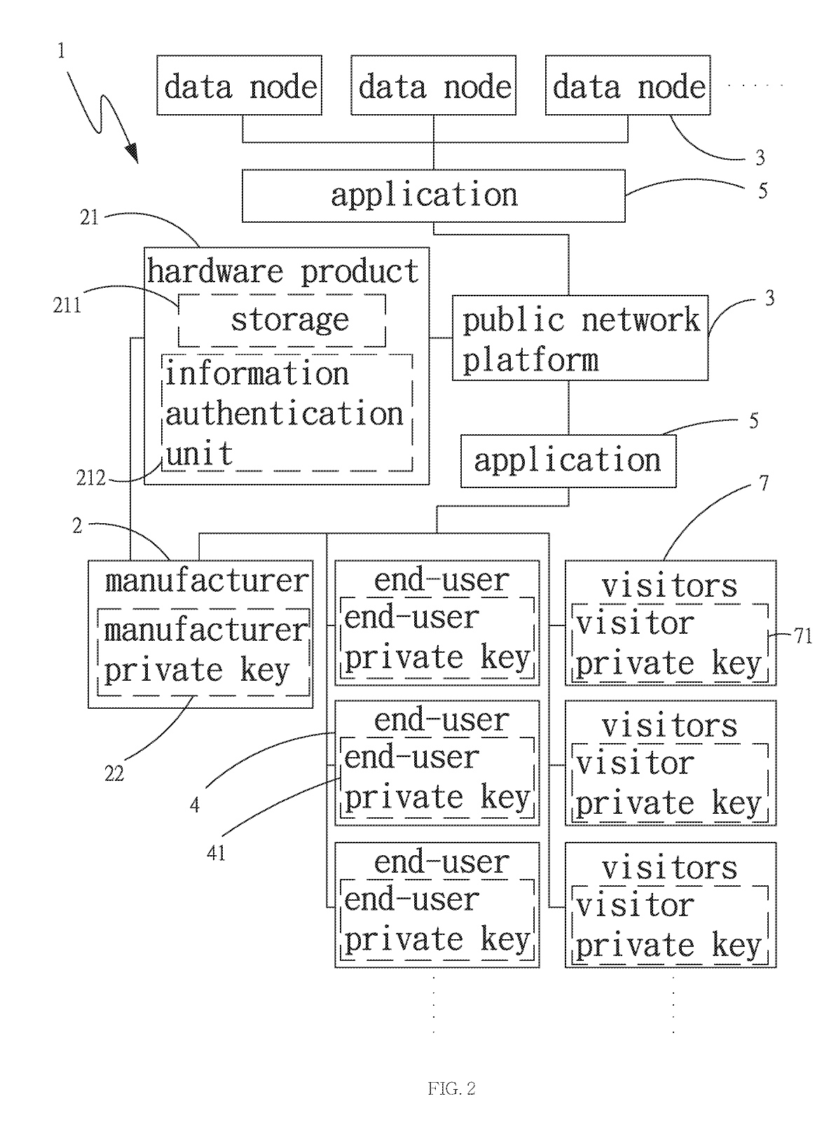

Referring to FIGS. 1 and 2, which show a schematic view and a block schematic view of a product information management system of the present invention, respectively, and it can be clearly seen from the drawings that a product information management system 1 comprises at least one manufacturer 2, at least one data node 3, and at least one end-user 4, wherein the manufacturer 2 is able to present at least one hardware product 21, and the manufacturer 2 enables producing product information for the hardware product 21. The product information comprises related product information, including supplier name, product name, product model, product ID (identification), warranty period, test data, and manufacturing place of origin. Moreover, the product information is further provided with first time information, wherein the first time information is the product information when written to a public network platform 6. Furthermore, a storage 211 and an information authentication unit 212 are installed on the hardware product 21, and the manufacturer 2 is installed with an application 5 operated through a computer equipment. In addition, the manufacturer 2 transmits the product information to the public network platform 6 through the aforementioned application 5, and the manufacturer 2 writes the product information to the public network platform 6 through a manufacturer private key 22. The manufacturer private key 22 comprises a first key and a second key associated with the manufacturer 2, wherein the first key is an information access module, and the second key is an identity matching module. In addition, when the manufacturer 2 writes the aforementioned product information, the application 5 concurrently transmits the product information to the storage 211 using wired, wireless, or optical methods. The storage 211 can be a hardware circuit or a software file, and prior to transmitting to the storage 211, the product information needs to be authenticated by the aforementioned information authentication unit 212. The product information thus passes through the aforementioned application 5 and authenticated by the information authentication unit 212, and then transmitted to the storage 211. Hence, the public network platform 6 can store a variety of product information related to the hardware product 21. Furthermore, the storage 211 concurrently stores the latest product information related to the aforementioned hardware product 21, or enables looking up the product history of the hardware product 21.

The data node 3 is similarly installed with the aforementioned application 5 through computer equipment, and the data node 3 can retrieve the product information on the public network platform 6 through the application 5 as well as carry out verification of the retrieved product information. The error-free verified product information is then transformed to become a product information bank and stored on the aforementioned public network platform 6 through the application 5.

In addition, if the end-user 4 wants to purchase the hardware product 21, then the end-user 4 can access the product information bank associated with the purchased hardware product 21 on the public network platform 6 through the aforementioned application 5 installed within the computer equipment, thereby enabling acquiring knowledge about the product information of the hardware product 21 through the product information bank. Moreover, the end-user 4 uses a end-user private key 41 associated with the end-user 4 to access the aforementioned product information, wherein the end-user private key 41 comprises a first key and a second key associated with the end-user 4. The first key is an information access module, and the second key is an identity matching module. Furthermore, after using the hardware product 21, the end-user 4 produces product use information through the aforementioned end-user private key 41 and the application 5, wherein the product use information comprises related product use information, including product use condition and product maintenance condition. Moreover, the product use information is further provided with second time information, wherein the second time information is the product use information when written to the public network platform 6. The end-user 4 then writes the product use information to the public network platform 6 through the application 5 matched with use of the user's key. And when the end-user 4 writes the product use information, the application 5 concurrently transmits the product information to the storage 211 using wired, wireless, or optical methods. In addition, prior to transmitting to the storage 211, the product information is necessarily authenticated by the aforementioned information authentication unit 212. The product use information is then transmitted to the storage 211, thus, the public network platform 6 can store a variety of product use information of the hardware product 21. Moreover, the storage 211 concurrently stores the latest product use information of the aforementioned hardware product 21.

Accordingly, the data node 3 retrieves the product information bank and product use information on the public network platform 6 through the aforementioned application 5 and verifies the retrieved product information bank and product use information. The error-free verified product information bank and product use information is then transformed to become the same product information bank, which is also stored on the public network platform 6 through the application 5. Apart from being able to access and write to the product information bank on the public network platform 6 through the aforementioned manufacturer 2, the end-user 4 can also access and write to the product information bank. The aforementioned data node 3 is able to verify all the written data of the manufacturer 2 and the end-user 4, thereby enabling convenient assessment of the product information bank on the public network platform 6. Moreover, the characteristics of decentralized distribution computation and authentication and disallowing unilateral change of data enable providing traders with impartial grading standards when trading products.

Furthermore, when the public network platform 6 is provided with the aforementioned product information bank, at least one visitors 7 is able to access the product information bank, wherein computer equipment of the visitors 7 is installed with the aforementioned application 5, thereby enabling the visitors 7 to access the product information bank through the application 5. The visitors 7 accesses the product information through a visitor private key 71, wherein the visitor private key 71 is a data access module. The visitor private key 71 has sole data access authority, and the visitors 7 can acquire knowledge about product information and product use information of the hardware product 21 through the product information bank. Moreover, the product information and the product use information is further provided with the aforementioned first time information and the second time information, and the visitors 7 can acquire explicit knowledge about the product history of the hardware product 21. In addition, results from decentralized distribution computation further enable facilitating assessment of data within the product information bank, providing impartiality and facilitating the manufacturer 2, the end-user 4, and the visitors 7 to acquire explicit knowledge and accurate data, thereby achieving the object of preventing consumer disputes from occurring.

Moreover, if the aforementioned product information bank is accessed and the hardware product 21 is purchased and used, then the visitors 7 is transformed to the end-user 4. The end-user 4 can then produce product use information through the aforementioned end-user private key 41 and the aforementioned application 5, wherein the product use information comprises related product use information, including product use condition and product maintenance condition. Furthermore, during the process of writing product use information to the product information bank, new product use information is additionally appended to the original product use information of the hardware product 21, but the original product use information and product information is left unaltered. And when the end-user 4 is writing the aforementioned new product use information, the application 5 concurrently transmits the product information to the storage 211 using wired, wireless, or optical methods, wherein the product information must be authenticated by the aforementioned information authentication unit 212 prior to transmitting to the storage 211, and only after authentication can the product use information be transmitted to the storage 211. However, if the hardware product 21 undergoes maintenance through the manufacturer, then the manufacturer 2 produces new product information through the manufacturer private key 22 and the application 5. In addition, the process of writing product information to the information bank involves writing the latest product information of the hardware product 21, wherein product information and product use information are concurrently provided with the aforementioned first time information and the second time information to explicitly display the time points when the revised information was written, as well enabling inquiring about all past records from the product information bank. Moreover, the first time information and the second time information are produced from GPS (global positioning system) data or a network timing server. Accordingly. time points of the first time information and the second time information are absolutely explicit and accurate.

Furthermore, the data node 3 retrieves the product information bank and product use information written to the public network platform 6 through the application 5, whereupon the retrieved product information and product use information is verified. The error-free verified product information bank and product use information are then transformed to become the same product information bank and stored on the public network platform 6 and the storage 211 through the application 5, thereby enabling convenient assessment of the product information bank on the public network platform 6. Moreover, the characteristics of decentralized distribution computation and authentication and disallowing unilateral change of data enable traders to carry out fair trading of the hardware product 21. Hence, when the hardware product 21 is purchased and used by another end-user 4, the original product use information is continually updated with the new written product use information and paired with third time information for display thereof; or maintenance is carried out through the manufacturer 2, and the product information concurrently continues to update the original product information and paired with fourth time information for display thereof. The data node 3 then continues to retrieve the new product information and product use information for verification, and transforms this information to become the product information bank until the hardware product 21 is reported for deletion. While the new product information and product use information continues to increase, the time information thereof also continues to be produced along with the GPS data or a network timing server.

It's worth mentioning that block chaining technology is used as the verification method to verify the product information and product use information but is not limited by such. Accordingly, the characteristics of decentralized distribution computation and authentication and disallowing unilateral change of data provide the product information bank on the public network platform with reliability and impartiality. And, compared to the transaction module of discretionary trading, the verified product information bank is better matched with actual product value, providing the trader with impartial grading standards during product trading.

It is of course to be understood that the embodiments described herein are merely illustrative of the principles of the invention and that a wide variety of modifications thereto may be effected by persons skilled in the art without departing from the spirit and scope of the invention as set forth in the following claims. For example, all equivalent effects produced by various changes, modifications, and uses of the structural form or configuration of the present invention, such variations are to be considered as included in the following claims.

What is claimed is:

1. A product information management system using block chain repository and methodology, comprising:
at least one manufacturer, wherein the manufacturer is provided with at least one hardware product, and the hardware product is provided with product information, and the product information comprises at least one first time information; the manufacturer transmits the product information to a public network platform through an application;
at least one data node, wherein the data node retrieves product information through the application, and the data node transforms the retrieved product information to become a product information bank, and the application stores the product information bank on the public network platform;
at least one end-user, wherein the end-user accesses the product information bank through the application on the public network platform; the end-user uses the hardware product and transmits product use information to the public network platform through the application, and the product use information comprises at least one second time information, and the data node verifies the product information and the product use information, which are then transformed to become the product information bank and stored on the public network platform.

2. The product information management system using block chain repository and methodology according to claim 1, wherein an storage and an information authentication unit are installed on the hardware product, the product information bank is stored within the storage, and the product information bank is transmitted to the public network platform through the application; the storage is a hardware circuit or a software file, and the storage mutually communicates with the public network platform through the application and carries out authentication.

3. The product information management system using block chain repository and methodology according to claim 2, wherein the manufacturer accesses the product information bank through the application; the manufacturer writes the product information through a manufacturer private key, and then transmits the revised product information to the public network platform through the application, and the latest product information is updated to the storage of the hardware product, wherein the manufacturer private key comprises a first key and a second key, the first key is an information access module and the second key is an identity matching module.

4. The product information management system using block chain repository and methodology according to claim 1, wherein the end-user accesses the product information bank through the application; the end-user writes the product use information through a end-user private key, and then transmits the revised product use information to the public network platform through the application, wherein the end-user private key comprises a first key and a second key, the first key is an information access module and the second key is an identity matching module.

5. The product information management system using block chain repository and methodology according to claim 1, further comprising at least one visitors, wherein the manufacturer accesses the product information bank through the application, and the visitors accesses the product information bank through a visitor private key, wherein the visitor private key is an information access module.
